(19) United States
(12) Patent Application Publication
(10) Pub. No.: US 2014/0089234 A1
(43) Pub. Date: Mar. 27, 2014

(54) INTERACTIVE VISUALIZATION OF MULTI-OBJECTIVE OPTIMIZATION

(71) Applicants: Peter Cacipooppi, (US); INTERNATIONAL BUSINESS MACHINES CORPORATION, Armonk, NY (US)

(72) Inventors: Peter Cacioppi, Eugene, OR (US); Allen S. Crowley, Eugene, OR (US); Ryan N. Hennings, Eugene, OR (US)

(73) Assignee: INTERNATIONAL BUSINESS MACHINES CORPORATION, Armonk, NY (US)

(21) Appl. No.: 13/624,393

(22) Filed: Sep. 21, 2012

(51) Int. Cl. G06F 15/18

(52) U.S. Cl. 706/12

(57) ABSTRACT

A method for interactive visualization of multi-objective optimization is described. The method includes displaying a visualization of an approximation to a Pareto frontier for a multi-objective problem in a user interface. The method also includes updating the visualization of the approximation in real-time in response to finding a solution to the multi-objective problem while the multi-objective problem is being optimized.

### BACKGROUND

Multi-objective optimization is the process of optimizing objective functions in a model. For example, minimizing production costs may cause inventory holding costs to increase, and vice versa. Multi-objective problems generally have several solutions—solutions where it is impossible to improve one objective without worsening the other objective. A solution that fits this description is called Pareto optimal, and the set of all Pareto optimal solutions is known as the Pareto frontier.

A natural way to visualize the Pareto frontier in a multi-objective problem with two objectives is to display the solutions as points on a graph, where each of the graph axes represents one of the objectives. However, the process of finding all the Pareto optimal points can be very time-consuming. Additionally, a user running a multi-objective optimization may discover that parts of the Pareto frontier are uninteresting—for example, parts of the graph where a small improvement in one objective causes a very large penalty in the other objective.

### SUMMARY

Embodiments of a method are described. In one embodiment, the method is a method for interactive visualization of multi-objective optimization. The method includes displaying a visualization of an approximation to a Pareto frontier for a multi-objective problem in a user interface. The method also includes updating the visualization of the approximation in real-time in response to finding a solution to the multi-objective problem while the multi-objective problem is being optimized. Other embodiments of the method, a system, and a computer program product are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a multi-objective optimization system.

FIG. 2 depicts a schematic diagram of one embodiment of a visualization of an approximation of a Pareto frontier.

FIG. 3 depicts a schematic diagram of one embodiment of a visualization of an approximation of a Pareto frontier.

FIG. 4 depicts a schematic diagram of one embodiment of a visualization of an approximation of a Pareto frontier.

FIG. 5 depicts a schematic diagram of one embodiment of a visualization of an approximation of a Pareto frontier.

FIG. 6 depicts a schematic diagram of one embodiment of a visualization of an approximation of a Pareto frontier.

FIG. 7 depicts a schematic diagram of one embodiment of a visualization of an approximation of a Pareto frontier.

FIG. 8 depicts a flowchart diagram of one embodiment of a method for interactive visualization of multi-objective optimization.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for interactive visualization of multi-objective optimization. More specifically, the system displays a visualization of an approximation of a Pareto frontier for a multi-objective problem. The visualization is updated in real-time as solutions to the multi-objective problem are found. The system is also configured to receive user selections to interact with or modify various aspects of the visualization.

Some conventional systems describe interactive graphs for multi-objective functions that allow a user to interact with a visualization that describes the solutions to the multi-objective functions. However, such systems only allow the user to interact with the visualization once the optimization is completed. Consequently, a system that enables a user to interact with a visualization to view the results of the optimization in real-time while the optimization of the multi-objective problem is still running may reduce the time needed to present worthwhile solutions to the user. Additionally, a system that allows the user to direct the optimizer to prioritize finding solutions in parts of the graph the user considers interesting may further reduce the time needed to find solutions preferred by the user.

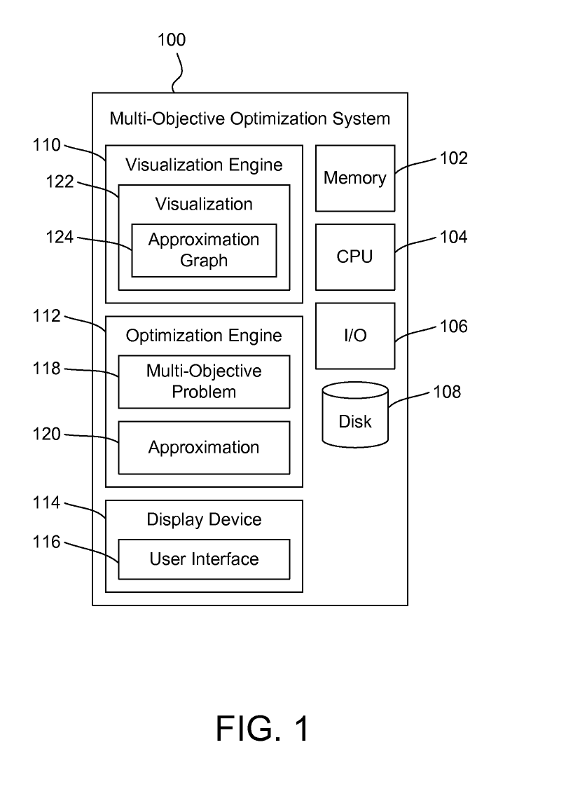

FIG. 1 depicts a schematic diagram of one embodiment of a multi-objective optimization system 100. The depicted optimization system 100 includes various components, described in more detail below, that are capable of performing the functions and operations described herein. In one embodiment, at least some of the components of the optimization system 100 are implemented in a computer system. For example, the functionality of one or more components of the optimization system 100 may be implemented by computer program instructions stored on a computer memory device 102 and executed by a processing device 104 such as a CPU. The optimization system 100 may include other components, such as input/output devices 106, a disk storage drive 108, a visualization engine 110, an optimization engine 112, and a display device 114. Some or all of the components of the optimization system 100 may be stored on a single computing device 104 or on a network of computing devices 104, including a wireless communication network. The optimization system 100 may include more or fewer components or subsystems than those depicted herein. In some embodiments, the optimization system 100 may be used to implement the methods described herein as depicted in FIG. 9.

A user interface 116 is displayed on the display device 114. The display device 114 may be any display device 114 for a computing device. The user interface 116 may be part of an operating system for the computing device. The user interface 116 may allow the user to interact with the operating system and applications within the operating system. The operations described herein may be associated with one or more applications configured to operate within the operating system. In one embodiment, the visualization engine 110 and the optimization engine 112 are associated with one or more applications.

The optimization engine 112 is configured to optimize a multi-objective problem 118 to obtain Pareto optimal solutions in a Pareto frontier. The Pareto frontier includes the full set of Pareto optimal solutions. The optimization engine 112 is also configured to determine an approximation 120 to the Pareto frontier while the multi-objective problem 118 is still being optimized. The approximation 120 includes solutions for the multi-objective problem 118 while the multi-objective problem 118 is still running, such that further optimization of the multi-objective problem 118 may be done by the optimization engine 112.

The visualization engine 110 displays a visualization 122 of the approximation 120. The visualization 122 is displayed on the user interface 116 to allow the user to view and interact with the visualization 122 in real-time as the optimization engine 112 is finding solutions for the multi-objective problem 118. For example, if the visualization 122 includes an approximation graph 124 having an axis for each of the objectives in a two-objective problem 118, the solutions may be plotted on the graph 124 relative to the axes.

The user may interact with the visualization 122 via the user interface 116. In one embodiment, the visualization engine 110 is configured to modify an element of the visualization 122 in response to receiving a user selection. The user selection may include selections to perform various operations that modify the look of the visualization 122 or that modify how the optimization engine 112 optimizes the multi-objective problem 118. The user selection may modify the visualization 122 or optimization of the multi-objective problem 118 in real-time while the multi-objective problem 118 is being optimized.

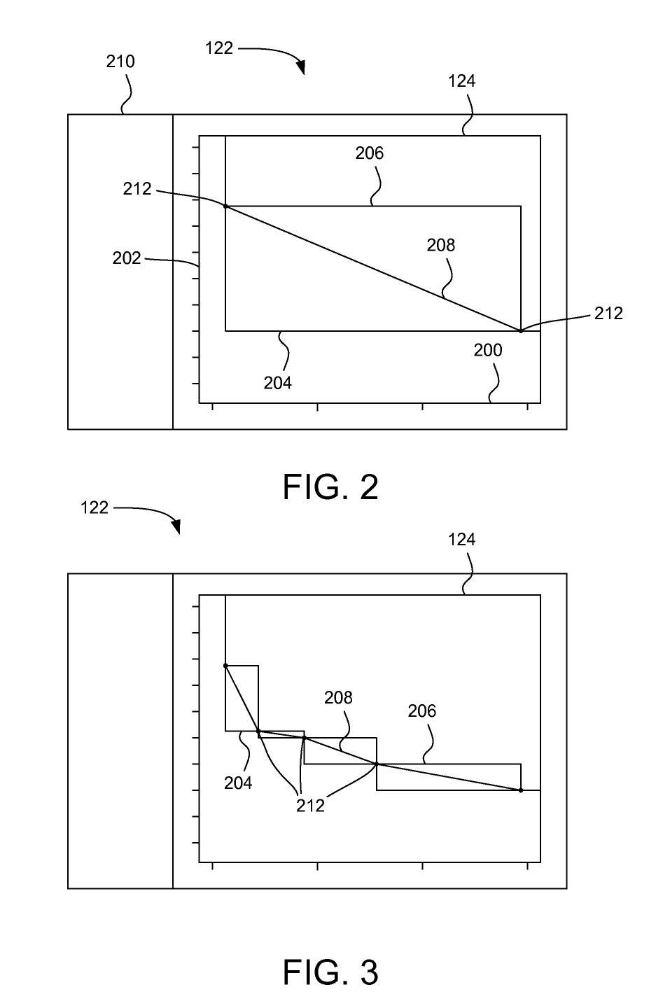

FIGS. 2-7 depict schematic diagrams of various embodiments of a visualization 122 of an approximation 120 of a Pareto frontier. While the multi-objective optimization system 100 is depicted in conjunction with the visualizations 122 of FIGS. 2-7, the multi-objective optimization system 100 may be used in conjunction with any type of visualization 122.

In the embodiment of FIG. 2, the visualization 122 includes an approximation graph 124 that plots solutions 212 found by optimizing the multi-objective problem 118. The axes 200, 202 for the approximation graph 124 may correspond to objectives for the multi-objective problem 118. The approximation graph 124 may show the lower bound 204 and upper bound 206 of the approximation 120 of the Pareto frontier as currently calculated. The approximation graph 124 may also include a linear trace 208 connecting the known solutions 212 to the multi-objective function.

In one embodiment, the upper bound 206 defines the achievable frontier and the lower bound 204 defines the impossible frontier. As the multi-objective problem 118 is optimized, the upper bound 206 and the lower bound 204 are moved closer together as more solutions 212 are found. While the computational task of fully closing the gap between the two frontiers is intractable in the general case, the two frontiers may be brought to within a reasonable tolerance in many models.

The visualization 122 may also include additional visual elements that the user may interact with. For example, the visualization 122 may include selectable options proximate in a side panel 210 the approximation graph 124. The visualization 122 may also display detailed information in the side panel 210, such as a legend describing the visual elements of the visualization 122. In the embodiment of FIG. 2, the approximation graph 124 displays two solutions 212 that have been found for the multi-objective problem 118.

Though the visualization 122 in FIG. 2 is shown with a side panel 210 proximate an approximation graph 124, the visualization 122 may include any type or configuration of visualization 122 to depict the approximation 120 to the Pareto frontier and any information or operations related to the approximation 120.

In the embodiment of FIG. 3, three additional solutions 212 have been found for the approximation 120 for the multi-objective problem 118 of FIG. 2. The visualization 122 may update with each new solution 212 that is found. As new solutions 212 are found, the lower bound 204 and upper bound 206 are adjusted to reflect the new achievable and impossible frontiers. For example, as new solutions 212 are found, the lower and upper bounds 204, 206 move closer together. Additionally, the linear trace 208 is adjusted to pass through the new solutions 212.

The visualization 122 may update after a predetermined number of new solutions 212 have been found. The visualization 122 may update after a predetermined amount of time has passed since the last update. The visualization 122 may update in response to a user selection to update the visualization 122. In some embodiments, the visualization 122 may use a combination of the criteria described above and/or other criteria to determine when to update.

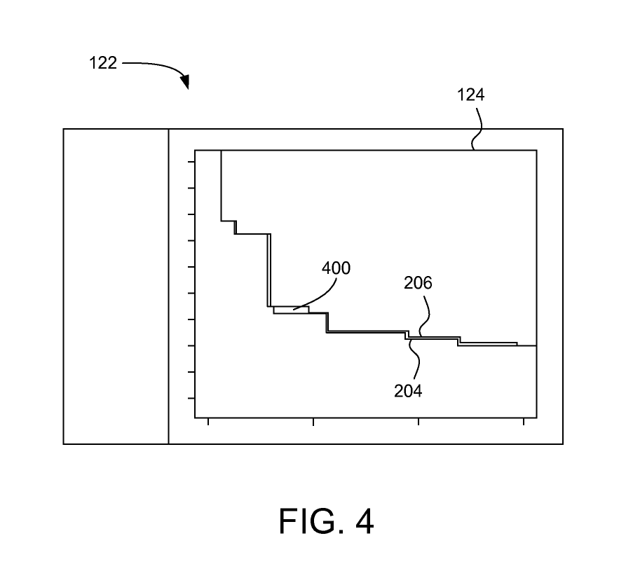

In the embodiment of FIG. 4, the optimization of the multi-objective problem 118 is completed, such that the gap between the achievable frontier and the impossible frontier is optimized. Because the achievable frontier and the impossible frontier may not meet, the visualization 122 may show a gap 400 between the upper bound 206 and the lower bound 204. In some embodiments, the gap 400 may be sufficiently small that no gap 400 is discernible. In the optimized visualization 122, the linear trace 208 may be removed to allow the user to more easily view the upper bound 206 and the lower bound 204.

While the embodiments depicted herein display lower bounds 204 and upper bounds 206 representing impossible frontiers and achievable frontiers that touch at some point in the approximation graph 124, there may be embodiments of visualizations 122 for multi-objective problems in which the frontiers do not meet at any point in the approximation graph 124.

For example, the visualization strategy also encompasses models for which it is computationally intractable to find the provable optimal solution for just one objective. A common strategy for such a model is to solve the problem with an optimization tolerance (Delta), i.e., to return a solution with a specific cost X and a lower bound value Y, where Y=X−Delta, and where it is a mathematical certainty that no solution exists with cost less than Y. When such a computational technique is applied to problems with more than one objective, the resulting approximation 120 to the Pareto frontier often contains an impossible frontier and an achievable frontier that never touch, and whose angles are out of alignment. Nevertheless, an approximation graph 124 may still describe a very accurate approximation 120 and provide meaningful insight to the user.

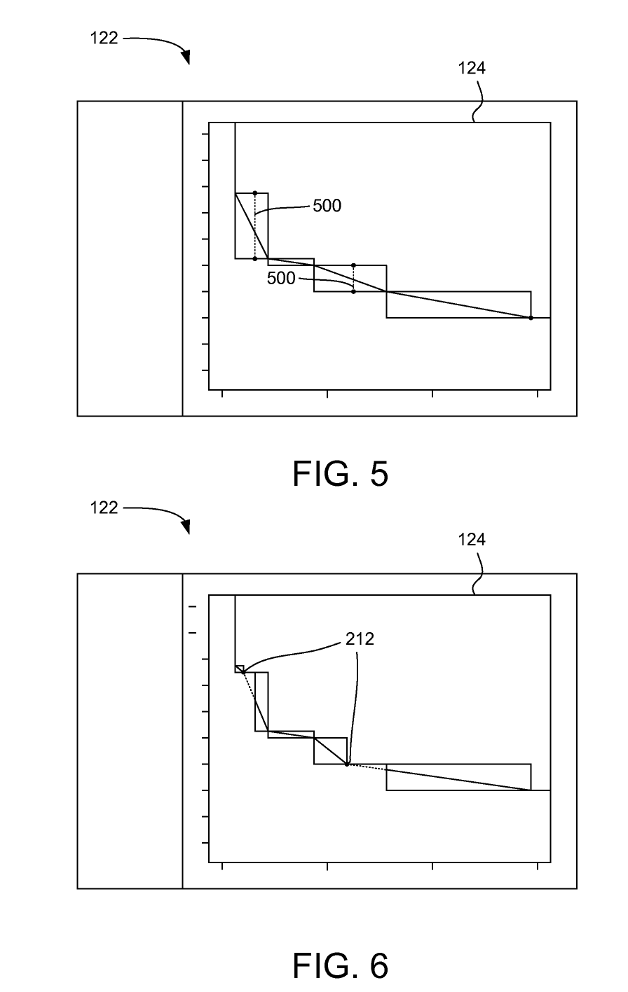

In one embodiment, such as depicted in FIG. 5, the user may select targets 500 in the visualization 122. Each target 500 may correspond to a section or point in the approximation graph 124 for which the user desires to view more details. The user may add a target 500 by clicking and dragging to a specific horizontal location on the approximation graph 124. The target 500 is displayed as a vertical line or vertical dashed line between the lower bound 204 and upper bound 206 indicating the range of possible values for a solution 212 found at the target's location. When the user has chosen a location, the optimizer attempts to find a solution 212 which minimizes a primary objective (corresponding to the y-axis 202 of the approximation graph 124) while maintaining a secondary objective value (corresponding to the x-axis 200) less than or equal to the value that the user selected by dragging the target 500 along the x-axis 200. The user may select any number of targets 500.

The optimization system 100 finds and/or stores a solution 212 for each target 500 within the range of values indicated by the target lines. In some embodiments, the optimization system 100 may find more than one solution 212 for a single target 500. The optimization system 100 may be configured to eliminate any solutions 212 that are less than optimal within the target range. The user may also determine that a solution 212 is not optimal. The embodiment of the visualization 122 depicted in FIG. 6 includes solutions 212 found for the targets 500 shown in FIG. 5.

The user may view detailed information for each solution 212 found for the corresponding targets 500 or for other solutions 212 that have already been found by the optimization system 100 prior to selecting targets 500. The detailed information may describe aspects of the solutions 212 that may not be shown in detail in the visualization 122. For example, the detailed information may include a breakdown of how the objective values are achieved, how one objective value might affect another objective value, or other details.

Because the target 500 includes a threshold value for the secondary objective, solutions 212 found corresponding to the indicated targets 500 may cause one of the lower bound 204 or the upper bound 206 to cross the linear trace 208 for the known solutions 212, such that the linear trace 208 falls outside the current approximation 120 to the Pareto frontier. When the linear trace 208 falls outside the approximation 120, the portions that fall outside the approximation 120 may be indicated to the user, such as by displaying those portions as a dashed or dotted line, or by using some other visual indication that the user may easily recognize.

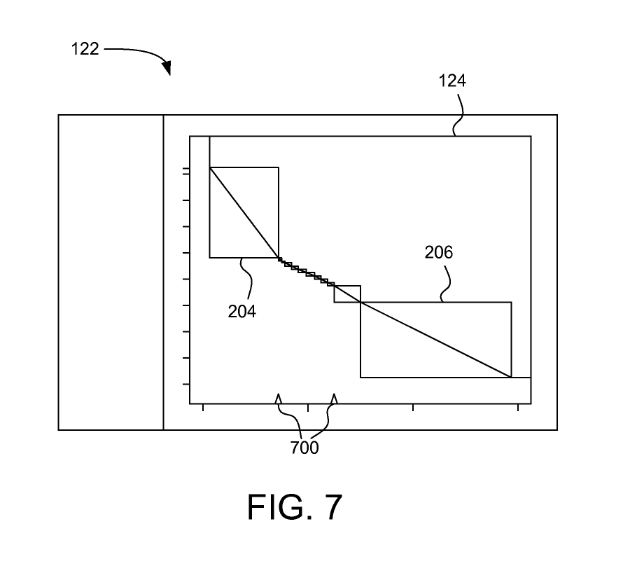

In one embodiment, the user may select an area within the visualization 122 for focusing the optimization system 100. The selected area may indicate a range of values that the optimization system 100 should solve before solving other values for the multi-objective problem 118. The user may select the area by manipulating a visual artifact on the visualization 122. For example, as depicted in FIG. 7, the visual artifacts may be focus arrows 700 that the user may slide along the x-axis 200 to identify the leftmost and rightmost points for a range of values for the optimization system 100 to solve first. The leftmost and rightmost points may then be communicated to the optimization system 100, which then works on resolving that portion of the approximation graph 124 before moving on to the remainder of the approximation graph 124.

In some embodiments, the focus arrows 700 may not completely prevent the optimization system 100 from performing any optimization outside the selected area, but instead may assign a higher priority to the selected area. As shown in the current embodiment, the optimization system 100 improves the accuracy of the approximation 120 between the focus arrows 700 while leaving the rest of the approximation 120 mostly unexplored. Once the selected area has been optimized to a certain tolerance between the achievable frontier and the impossible frontier, the optimization engine 112 may begin focusing on portions of the approximation 120 outside the selected area.

In one embodiment, the user slides the focus arrows 700 to specific points along the x-axis 200 to indicate the leftmost and rightmost points of the desired range. The optimization system 100 may start finding solutions 212 for the specific range as soon as the user moves one or both of the focus arrows 700 to the specific points along the x-axis 200. For example, if the user moves the right focus arrow to the left, the optimization system 100 may immediately narrow the focus to the range of values defined by the right focus arrow, which has been moved by the user, and the left focus arrow, which has not been moved by the user. Alternatively, the optimization system 100 may detect that the user has moved both focus arrows 700 before changing the focus. In another embodiment, the user performs an action, such as a button click or other action, to indicate that the optimization system 100 should calculate the focus range.

While the embodiment of FIG. 7 depicts focus arrows 700 for defining the focus range of the optimization system 100, the optimization system 100 may include other ways of defining the focus range. For example, the user may enter the leftmost and rightmost values for the range in a text field or by manipulating some other visual artifact or identifier to the desired locations on the approximation graph 124.

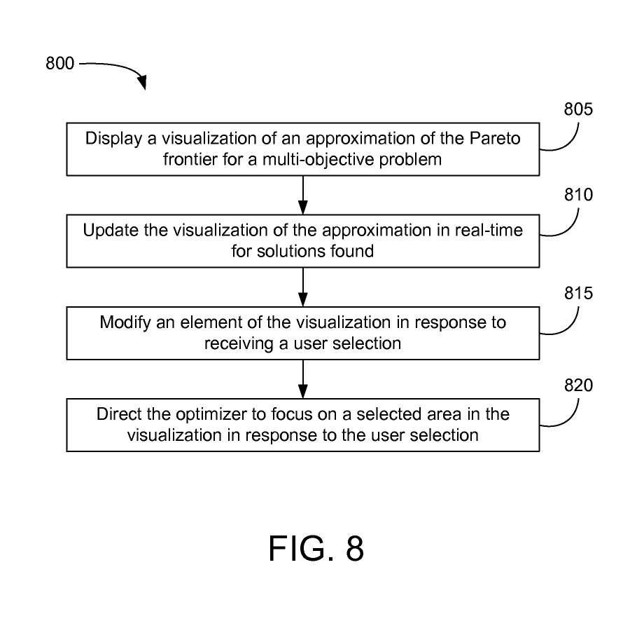

FIG. 8 depicts a flowchart diagram of one embodiment of a method 800 for interactive visualization 122 of multi-objective optimization. Although the method 800 is described in conjunction with the multi-objective optimization system 100 of FIG. 1, the method 800 may be used in conjunction with any type of multi-objective optimization system 100.

The optimization system 100 is configured to display 805 a visualization 122 of an approximation 120 of the Pareto frontier for a multi-objective problem 118 in a user interface 116. The visualization 122 may present optimization paths corresponding to the approximation 120 as an approximation graph 124 or some other visualization 122 that allows the user to view and interact with the approximation 120. In an approximation graph 124, the axes 200, 202 of the approximation graph 124 may represent the objectives for the multi-objective problem 118.

The optimization system 100 updates 810 the visualization 122 of the approximation 120 in real-time in response to finding a solution 212 to the multi-objective problem 118 while the multi-objective problem 118 is being optimized. Updating the visualization 122 of the approximation 120 in real-time allows the user to view solutions 212 before the multi-objective problem 118 is completely optimized. Finding all the achievable solutions 212 using the underlying multi-objective algorithm may take a significant amount of time.

The optimization system 100 may also modify 815 an element of the visualization 122 in response to receiving a user selection. The user may select a modification via the user interface 116, such as by interacting with the approximation graph 124 or a control associated with the approximation graph 124, for example. In one embodiment, the user selection includes directing 820 an optimizer to focus on a selected area in the visualization 122. The optimization engine 112 focuses on the selected area and presents solutions 212 for the multi-objective problem 118 within the selected area before finding solutions 212 outside the selected area. In one embodiment, the selected area is determined using visual indicators on an axis of the approximation graph 124.

The user selection may include selecting a solution 212 in the visualization 122. The optimization system 100 may display detailed information corresponding to the solution 212. For example, the optimization system 100 may compare the solution 212 to one or more other solutions 212 in the visualization 122 using a detailed comparison report. This may show the user the effects of trading one objective for another. Additionally, the user may hover over one of the solutions 212 (represented by a dot or other visual indicator) to find the name of the corresponding scenario, which in turn can be selected from a scenario manager. After selecting a scenario, the full range of detailed reports for one or more solutions 212 may be studied and/or compared. The run time to generate reports for a large number of solutions 212 can be considerable, and the associated memory footprint may become unreasonably large. The scenarios listed in the scenario manager may also become less useable, as the distinctions between the many different solutions 212 may be very minor. Consequently, while the optimization system 100 may discover and plot a large number of solutions 212 in the visualization 122, the optimization system 100 may choose to store detailed reports for a small subset of the discovered solutions 212 for viewing in the scenario manager.

In one embodiment, the user may add one or more targets 500 on a specific location of the approximation graph 124 to add solutions 212 to a set of stored solutions and to further increase the accuracy of the approximation 120. The optimization system 100 may display the target 500 as a vertical line indicating a range of possible values for the solution 212 at the specific location. The optimization system 100 then finds the solution 212 which minimizes a primary objective value while maintaining a secondary objective value at or below a selected threshold. The selected threshold may be determined based on the horizontal position of the target 500 on the x-axis 200 as selected by the user. The optimization system 100 then adds the solution 212 corresponding to the target 500 to a set of stored solutions for which the optimization system 100 may store detailed information in addition to plotting the solution 212 on the approximation graph 124. The frontiers may also be updated to reflect the newly found/stored solution 212.

In one embodiment, the user selection includes an indication by the user to swap the axes 200, 202 of the approximation graph 124. The optimization system 100 then swaps the axes 200, 202 of the approximation graph 124 and updates the visualization 122 to reflect the change. Swapping the axes 200, 202 of the approximation graph 124 may be useful for areas of the graph 124 which are very narrow either horizontally or vertically—for example, an area where a small change in one objective causes a large change in the other objective. Swapping the axes 200, 202 may allow the user to more easily view the differences between the solutions 212. Swapping the axes 200, 202 may also give the user a larger horizontal area, for example, in which to move the focus arrows 700 and to add targets 500.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

An embodiment of a multi-objective optimization system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for interactive visualization of multi-objective optimization, the operations comprising:
displaying a visualization of an approximation to a Pareto frontier for a multi-objective problem in a user interface; and
updating the visualization of the approximation in real-time in response to finding a solution to the multi-objective problem while the multi-objective problem is being optimized.

2. The computer program product of claim 1, wherein the computer readable program, when executed on the computer, causes the computer to perform additional operations, comprising:
modifying an element of the visualization in response to receiving a user selection.

3. The computer program product of claim 2, wherein the user selection comprises directing an optimizer to focus on a selected area in the visualization, wherein the operations further comprise presenting solutions for the multi-objective problem within the selected area before finding solutions outside the selected area.

4. The computer program product of claim 3, further comprising:
presenting optimization paths corresponding to the approximation as an approximation graph, wherein the selected area is determined using visual indicators on an axis of the approximation graph.

5. The computer program product of claim 4, wherein the user selection comprises selecting a solution in the visualization, wherein the operations further comprise displaying detailed information corresponding to the solution.

6. The computer program product of claim 4, further comprising:
adding a target on a specific location of the approximation graph:
displaying the target using a visual element to indicate a range of possible values for the solution at the specific location;
finding the solution which minimizes a primary objective value while maintaining a secondary objective value at or below a selected threshold; and
adding the solution corresponding to the target to a set of stored solutions.

7. The computer program product of claim 4, wherein the user selection comprises an indication to swap axes of the approximation graph, wherein the operations further comprise swapping the axes of the approximation graph.

8. A method for interactive visualization of multi-objective optimization, the operations comprising:
displaying a visualization of an approximation to a Pareto frontier for a multi-objective problem in a user interface; and
updating the visualization of the approximation in real-time in response to finding a solution to the multi-objective problem while the multi-objective problem is being optimized.

9. The method of claim 8, further comprising:
modifying an element of the visualization in response to receiving a user selection.

10. The method of claim 9, wherein the user selection comprises directing an optimizer to focus on a selected area in the visualization, wherein the method further comprises presenting solutions for the multi-objective problem within the selected area before finding solutions outside the selected area.

11. The method of claim 10, further comprising:
presenting optimization paths corresponding to the approximation as an approximation graph, wherein the selected area is determined using visual indicators on an axis of the approximation graph.

12. The method of claim 11, wherein the user selection comprises selecting a solution in the visualization, wherein the method further comprises:
displaying detailed information corresponding to the solution; and
comparing the solution to a second solution in the visualization using a detailed comparison report.

13. The method of claim 11, further comprising:
adding a target on a specific location of the approximation graph:
displaying the target using a visual element to indicate a range of possible values for the solution at the specific location;
finding the solution which minimizes a primary objective value while maintaining a secondary objective value at or below a selected threshold; and
adding the solution corresponding to the target to a set of stored solutions.

14. The method of claim 11, wherein the user selection comprises an indication to swap axes of the approximation graph, wherein the method further comprises swapping the axes of the approximation graph.

15. A multi-objective optimization system, comprising:
a display device comprising a user interface;
a visualization engine configured to display a visualization of an approximation to a Pareto frontier for a multi-objective problem in the user interface; and
an optimizer configured to update the visualization of the approximation in real-time in response to finding a solution to the multi-objective problem while the multi-objective problem is being optimized.

16. The system of claim 15, wherein the visualization engine is further configured to modify an element of the visualization in response to receiving a user selection.

17. The system of claim 16, wherein the user selection comprises directing an optimizer to focus on a selected area in the visualization, wherein the visualization engine is further configured to present solutions for the multi-objective problem within the selected area before finding solutions outside the selected area.

18. The system of claim 17, wherein the optimization engine is further configured to:
present optimization paths corresponding to the approximation as an approximation graph, wherein the selected area is determined using visual indicators on an axis of the approximation graph.

19. The system of claim 18, wherein the user selection comprises adding a target on a specific location of the approximation graph,
wherein the visualization engine is further configured to display the target using a visual element to indicate a range of possible values for the solution at the specific location,
wherein the optimization engine is further configured to:
find the solution which minimizes a primary objective value while maintaining a secondary objective value at or below a selected threshold; and
add the solution corresponding to the target to a set of stored solutions.

20. The system of claim 18, wherein the user selection comprises an indication to swap axes of the approximation graph, wherein the visualization engine is further configured to swap the axes of the approximation graph.
